(19) United States
(12) Patent Application Publication
(10) Pub. No.: US 2022/0307588 A1
(43) Pub. Date: Sep. 29, 2022

(54) AN ATTACHMENT FOR THE SHIFTER OF A GEARBOX OF A VEHICLE

(71) Applicant: Q SHIFT LIMITED, Hamitton (NZ)

(72) Inventors: Alan Blake JOHNSON, Hamilton (NZ); Glenn Douglas EVANS, Hamilton (NZ); Grant Antony UDY, Hamilton (NZ)

(21) Appl. No.: 17/639,034

(22) PCT Filed: Aug. 31, 2020
(86) PCT No.: PCT/NZ2020/050096

§ 371 Date: Feb. 28, 2022

(30) Foreign Application Priority Data
Aug. 30, 2019 (NZ) 756877

(51) Int. Cl. F16H 59/02; F16H 61/18; F16H 59/04; F16H 61/22

(52) U.S. Cl. CPC F16H 59/0278; F16H 61/18; F16H 59/04; F16H 61/22; F16H 2059/0282; F16H 2061/185; F16H 2059/048

(57) ABSTRACT

The invention is a shift lockout guide for a vehicle equipped with a manual gearbox. It includes a user-operable means that, in preferred embodiments, is mounted to the shifter of the gear box and is linked to an engagement portion that interacts with guide plates defining a path of travel for the shifter. A biasing means urges the engagement portion into the guide plates but this can be overridden by the driver through the user-operable means. The invention provides the driver of a vehicle fitted with the invention in the selection of specific gears while also preventing certain other gears from being selected. This reduces the risk of inadvertent overrevving of the vehicle's engine through inappropriate gear selection.

### FIELD OF INVENTION

The present invention relates to an apparatus for use with the shifter of a gearbox of a vehicle. The invention has particular application for guiding correct gear selection and preventing incorrect gear selection when operating a vehicle with a manual transmission gearbox.

### BACKGROUND TO THE INVENTION

In a vehicle utilising a manual transmission gearbox, gears are selected by the driver of the vehicle through manipulation of a lever referred to as a gear shifter or gear stick. Moving the gear shifter into specific positions selects specific gears within the gearbox, allowing the user to optimise the power output of the engine to the speed of the vehicle at any given time. The ser may also reverse the direction of output.

A shift pattern refers to the layout of the gear gate which determines the path the gear shifter can move through in order to select the required gear. A “standard H pattern” is a commonly utilised shift pattern for manual transmission gearboxes. The number of forward gears placed on a standard H pattern varies from 4 to 6, as does the positioning of reverse gear, depending upon the make and make of the vehicle.

An accidental misshift, where the driver inadvertently selects the wrong gear, will affect the performance of the vehicle and require a corrective action to be performed. Systems exist for helping drivers avoid selection of reverse gear when a forward gear is desired. However this still leaves the problem of accidental selection of incorrect forward gears.

When a lower than required gear is accidentally engaged and the road speed of the vehicle is faster than the gear selected will allow, the engine revolutions per minute will exceed a safe maximum. This is known as an “over-rev” and can result in significant damage to the engine and/or gearbox which can be expensive to repair or may even be irreparable in some instances.

Conversely, when a higher than desired gear is engaged, the engine revolutions drop away and the vehicle is less responsive to the accelerator. This may be a concern if the driver needs to take evasive action in an emergency. In a racing environment, this issue can have detrimental impact on the speed of the vehicle.

With a standard H pattern gearbox there are a number of possible misshifts, the most common being:
shifting from 2^{nd} to 3^{rd}, but accidentally selecting 1^{st} gear;
shifting from 2^{nd} to 3^{rd}, but accidentally selecting 5^{th} gear;
shifting from 5^{th} to 3^{rd}, but selecting 1st gear;
shifting from 5^{th} to 4^{th}, but selecting 2^{nd} gear.

Motorsport is the most common arena in which misshifts occur as rapid and less careful changes of gear are typical. This can be costly as engines used in motorsport are often finely tuned and extensively modified to optimise racing performance. It is clearly preferable to avoid damage to such an engine through inappropriate selection of gears.

Furthermore, motorsport vehicles often utilize “dog” engagement manual transmission gearboxes in preference to synchromesh gearboxes.

A synchromesh gearbox, as used in most manual transmission road vehicles, takes time to align the speeds of the gears prior to allowing the gear stick to fully engage the gear. If the wrong gear is selected with a synchromesh gearbox, the gear stick will resist the movement, indicating to the operator that the selection is incorrect.

In contrast, a dog engagement gearbox will allow a vehicle operator to shift into any gear, with no resistance against the gear stick, resulting in faster gear shift times. However, because the dog engagement gearbox will go straight into the gear selected, regardless of whether the selection was intentional or not, it is very easy to misshift, particularly when the external factors of racing are added (such as G forces when cornering, uneven road/track surfaces, heavy braking and shortened decision-making times). This means that the risk of damage to the engine as a result of inappropriate selection of gears is high.

Although costly misshifts occur primarily with dog engagement gearboxes used in racing/motorsport vehicles, drivers of road vehicles can also misshift where there are situations of stress or inexperience. Driving school vehicles are potentially at risk of costly damage from misshifts by inexperienced learner drivers as are high-performance supercars hired out to amateur enthusiasts to drive on track days.

### OBJECT OF THE INVENTION

It is an object of the invention to provide an apparatus for use in vehicles fitted with a manual gearbox, to prevent inappropriate gear selection.

Alternatively, it is an object of the invention to provide an apparatus for use in vehicles, particularly racing vehicles fitted with a manual gearbox, to reduce or eliminate the occurrence of a misshift by preventing selection of the wrong gear and assisting selection of the correct gear.

Alternatively, it is an object of the invention to provide an apparatus that can be readily and easily fitted to the manual gearbox of most makes and models of vehicles with minimal or no structural alterations to the gearbox or gear shift pattern

Alternatively, it is an object of the invention to provide a kit set for an apparatus that can be readily and easily fitted to most makes and models of vehicles with minimal or no structural alterations to the gear shift.

Alternatively, it is an object of the invention to at least provide the public with a useful choice.

### SUMMARY OF THE INVENTION

According to a first aspect of the invention, there is provided an attachment for a gear change assembly for a vehicle, wherein the gear change assembly includes a gear shifter for selection of a gear from a plurality of gears, wherein the attachment includes:
a user-operable means mounted to the gear shifter;
a biasing means, wherein the biasing means is configured to act against the user-operable means; and

a lockout means;

and wherein when the user-operable means is in a first position, the biasing means is deactivated enabling the gear shifter to select any gear from the plurality of gears, and wherein when the user-operable means is in a second position, the biasing means is activated, engaging the user-operable means with the lockout means to predetermine a specific gear from the plurality of gears for selection,

characterised in that

the lock out means includes an engagement portion and one or more guide plates, wherein the one or more guide plates are configured with a first surface defining a guide path for the engagement portion for selection of the specific gear from the plurality of gears for selection, and a second surface for selection of a further gear from the plurality of gears for selection.

According to a further aspect of the invention, there is provided a kit set for an attachment for a gear change assembly for a vehicle, wherein the gear change assembly includes a gear shifter for selection of a gear from a plurality of gears, wherein the kit set includes:
a user-operable means for mounting to the gear shifter;
a biasing means, wherein the biasing means is configured to act against the user-operable means; and
a lockout means;

and wherein when the user-operable means is in a first position, the biasing means is deactivated enabling the gear shifter to select any gear from the plurality of gears, and wherein when the user-operable means is in a second position, the biasing means is activated, engaging the user-operable means with the lockout means to predetermine a specific gear from the plurality of gears for selection,

characterised in that

the lock out means includes an engagement portion and one or more guide plates, wherein the one or more guide plates are configured with a first surface defining a guide path for the engagement portion for selection of the specific gear from the plurality of gears for selection, and a second surface for selection of a further gear from the plurality of gears for selection.

According to a further aspect of the invention, there is provided a kit set for an attachment for a gear change assembly for a vehicle, the kit set substantially as described above, but also including:
a gear shifter.

According to another aspect of the present invention, there is provided a vehicle, wherein the vehicle includes a gear change assembly including a plurality of gears and a gear shifter for selection of a gear from the plurality of gears, and wherein the vehicle includes an attachment, wherein the attachment includes a user-operable means mounted to the gear shifter, a biasing means, wherein the biasing means is configured to act against the user-operable means, and a lockout means, and wherein when the user-operable means is in a first position, the biasing means is deactivated enabling the gear shifter to select any gear from the plurality of gears, and wherein when the user-operable means is in a second position, the biasing means is actuated, engaging the user-operable means with the lockout means to predetermine a specific gear from the plurality of gears for selection, and wherein the lock out means includes an engagement portion and one or more guide plates, wherein the one or more guide plates are configured with a first surface defining a guide path for the engagement portion for selection of the specific gear from the plurality of gears for selection, and a second surface for selection of a further gear from the plurality of gears for selection.

The invention is an apparatus, henceforth referred to throughout the remainder of the specification as a shift lockout guide, that guides the driver of a vehicle fitted with the invention in the selection of specific gears and thereby reducing the risk of inadvertent overrevving of the vehicle's engine through inappropriate gear selection.

It will be understood the invention is for use with a vehicle having a manual gearbox or transmission. Such vehicles have a gearbox containing a plurality of forward gears and usually one reverse gear. The driver of the vehicle selects the desired gear using a gear shifter.

In exemplary embodiments, the gear shifter is a gear stick arising directly from the gear box of the vehicle. However, in some embodiments, the gear stick may be indirectly linked to the gearbox through the use of cables, rods or other linkages. Reference shall now be made to the gear shifter as being a gear stick although this is not meant to be limiting.

In exemplary embodiments, the shift lockout guide comprises at least three components configured to operate in conjunction with each other: the user-operable means, the biasing means, and a lock out means.

The user-operable means should be understood to be an apparatus or mechanism that is worked by the driver of the vehicle to operate the invention.

In exemplary embodiments, the driver only needs to perform a single motion to operate the invention.

In exemplary embodiments, the user operable means is mounted to and engages with the gear stick. This is preferred since in a vehicle with a manual gearbox, the driver will already have one hand on the gear stick when changing the gears. In this embodiment, the user operable means is simply raised and/or lowered in a single motion of the fingers of the driver to operate the invention.

However, it should be appreciated that in some forms the user operable means may be a button, lever or paddle or the like which is operative on, directly, via cables or the like on the biasing means, or alternatively wirelessly communicative with the biasing means. In these embodiments, the user operable means may be mounted to the steering wheel of the vehicle or to the top of the gear stick and similarly is operative with a single motion of the fingers of the driver.

In one embodiment of the invention, the user-operable means consists of a substantially cylindrical plunger configured to fit over the exposed shaft of the standard gear stick, i.e. the portion of the gear stick below the gear knob that is visible to the driver of the vehicle. This may require replacement of the existing gear knob. The user-operable means may include a surface that provides the driver with a gripping surface for selection of gears.

In an exemplary embodiment of the invention, the standard gear stick is replaced entirely with a gear stick specially constructed with an plunger integrated with or otherwise connected to the gear knob.

In some embodiments, the standard gear stick may be replaced with a gear stick having a shaft of two or more separate components. In these embodiments, the two or more separate components may be connected to each other such that they become a unitary structure through the use of a bracket or the like. Such embodiments may be useful since it may allow for a portion of the shaft of the gear stick to be angled relative to another portion of the shaft.

In some embodiments of the invention, the plunger is constructed from a metal alloy such as steel, preferably stainless steel. This is preferred for optimal strength and non-corrosive properties.

However, alternative embodiments may be constructed with other metals or plastics subject to material strength, durability and use in motorsport where it may be desirable for the invention to be as light as possible. For example, acetal, also known as polyoxymethylene, is an easily worked but hardwearing plastics material with a low co-efficient of friction when moving against metals or other plastics material.

In these embodiments, the plunger has a top or upper end and a bottom or lower end.

Preferably, the plunger is configured with a flange, collar or similar structure at or near its top end. This provides a positive surface that is gripped by the driver's fingers in order to raise the user-operable means. More low profile arrangements, such as nubs or the like could be used, but given the likely usage of the invention in motorsport, the manner by which the driver manipulates the user-operable means is preferably simple and easily engaged with gloved fingers. A flange is preferred for this reason. However, and as noted previously, the surface manipulated by the driver to move the user-operable means could alternatively be in the form of a lever or paddle that acts against the plunger.

The bottom end of the plunger is provided with a shaped flange or protrusion. This shaped flange, which shall now be referred to as an engagement portion, is configured to engage with a complementarily-shaped lockout means. It should be appreciated that the engagement portion forms part of the lockout means.

In this embodiment of the invention, the user-operable means and the engagement portion of the lock out means is a unitary structure. This simplifies manufacture and installation of the present invention. However, this is not meant to be limiting and in other embodiments of the invention, the user-operable means may be distinct from the engagement portion. In one such embodiment, the user-operable means and the engagement portion may be linked through the use of cables or rods or such like.

The biasing means should be understood to be a means by which the lockout means is capable or being urged or otherwise moved from a first position, where it is inoperative, to a second position, where it is operative.

In exemplary embodiments of the invention, the biasing means is an expansion spring or the like. However, in other embodiments, the biasing means may be an elastomer bung or the like. In further embodiments, the biasing means may be pneumatic or hydraulic pistons/plungers or even electromagnets or the like, which may be more suitable for wireless implementations of the invention.

In an exemplary embodiment of the invention, the biasing means is located between the gear stick knob and acts against the plunger. In other embodiments, where the engagement portion is separate from the user-operable means, the biasing means is located proximate the engagement portion.

In some embodiments, a biasing means, such as an expansion spring, may be located underneath the plunger, in isolation or in addition to a biasing means located at the gear stick knob. In other embodiments, the biasing means may be in the form of a push-pull cable; this embodiment may be conducive to arrangements where the portion of the user-operable means that is operated by the driver is positioned in a location separate from the gear stick, for example as a paddle or lever on the steering wheel. In exemplary embodiments of the invention, the biasing means is predisposed to urging the plunger, and therefore the engagement portion, downwards down the gear stick, without intervention by the driver. In this state, the biasing means should be considered active.

The first position of the lockout means should be understood to mean a position where a driver is able to select any gear of choice from the gearbox using the gear stick. The biasing means is overridden or made inactive, i.e. compressed by the driver pulling upwards, or otherwise operating with their fingers, on the user-operable means, the lock out means is in the first position. The second position of the lockout means should be understood to mean a position where the driver is able to only select pre-determined gears. The biasing means is active, i.e. urging the plunger/engagement portion downwards to place the lock out means in the second position. The driver is only able to select certain gears by moving the gear stick along predetermined paths.

In an exemplary embodiment of the invention, the lockout means is a two-part structure; the first is the engagement portion as previously described. The second part is a plate provided with a slot or aperture and configured to be fitted externally to or proximate the gear gate of the gearbox. The edges of the slot of the plate serves as a guide for the engagement portion. The plate shall be referred throughout the remainder of the present specification as a guide plate.

In some embodiments, the plate is a unitary structure that includes the slot or aperture at its centre. In other embodiments, the guide plate is formed from two or more separate plates which have opposing edges that together form a slot or aperture.

It should be appreciated that a portion of the edges of the slot define a first guide path for the engagement portion. A further guide path may be defined by other portions of the edges of the slot. The top or upper surface of the plate may form yet another guide path for the engagement portion.

In exemplary embodiments of the invention, the guide plate is constructed from a metal alloy such as stainless steel or, more preferably, aluminium, for being easy to work and relatively lightweight. This material is also preferred for its optimal strength and non-corrosive properties. However, alternative embodiments may be constructed with other metals or plastics subject to material strength, durability and use in motorsport where it may be desirable for the invention to be as light as possible.

This guide plate may be located in place through the use of appropriate fastening mechanisms, such as bolts or rivets or the like. In some embodiments, the guide plate may be part of or integrated into a housing the surrounds the gearbox. It will be appreciated that in use the gear stick passes through the slot and is able to move relative to the guide plate.

At least a portion of the slot includes an edge or portion having a contoured surface that is complementary to the engagement portion. The contoured surface defines an ideal path of travel or guide path along which the gear stick should travel in order to engage the desired gear.

In exemplary embodiments of the invention, when the engagement portion is lifted up, it is clear of the slot and may bear down on the top surface of the guide plate. Using the gear shifter, the driver can access any gear position dictated by the gear gate. When the plunger is released, the biasing means urges the plunger downward, into the second position, so that the engagement portion engages with the edges of the slot of the guide plate.

For example, as the gear stick is shifted from first to second gear, the engagement portion drops below the top step/surface of the guide plate. This effectively increases the diameter of the shaft of the gear stick. The contours of the guide plate physically blocks the gear stick from being able to be moved back into first gear. Instead, the contoured surface co-operates with the engagement portion to guide the gear stick along an ideal path into third gear.

The contoured guide plate and complementary profile of the engagement portion required to produce the ideal guide path for the gear stick to travel when shifting will vary for different gearboxes and makes/models of vehicle.

It should be appreciated that other embodiments of the invention may constitute variant guide plates with differing guide paths, depending on the desired gears that are to be prevented from being selected. In addition, in some embodiments, the respective components of the invention may be configured and arranged such that in a first configuration, certain gears are not available for selection, while in a second configuration, even more gears are unavailable for selection. For example, the guide plate may be configured with two or more steps.

In further embodiments of the invention, the plunger may be configured with a locking mechanism to disable the biasing means, i.e. place it in an inactive state when not required. This may take a variety of forms including, but not limited to, the use of clips, pins, and recesses.

In exemplary embodiments, the locking mechanism is operative in a single action by the driver's hand and/or fingers. This is preferred since it may make it easier to render the biasing means inactive while still driving.

In one example, this locking mechanism may be configured to include an L-shaped slot to engage with a notch when lifted and rotated. This will allow the plunger to remain locked in the first position i.e. lifted up, should the driver desire to disengage the shift lockout guide. In another example, the locking mechanism may be a pin that is inserted through the gear stick to prevent travel of the plunger.

It will be appreciated that modifications to the invention may be required depending on the arrangement or shift pattern of the gearbox. For example, when the gear box of some vehicles is such that reverse gear is placed next to first gear, the plunger may be configured for dual height adjustment, where lifting the plunger one step will allow the selection of first gear, while lifting the plunger two steps allows the selection of reverse gear. Alternatively, a dual height configuration could be used for gearboxes that place reverse next to six gear.

In an exemplary embodiment, the invention includes a housing that may be fixed above or around the gearbox of the vehicle such that the gear stick and/or the shaft of the gear stick passes substantially through the centre of the housing.

In this embodiment, the guide plate is received within the housing. It will be appreciated that this means that it is straightforward to change the guide plate depending on the preferences of the driver of the vehicle and which gears are to be locked out.

In some embodiments, the housing may be provided with a means of clamping the guide plate in place. In exemplary embodiments, the means of clamping is a plate that in use overlies the guide plate and is secured in place by screws or bolts.

In some embodiments, the housing may be provided with an adjustment means that allows the guide plates to be incrementally moved in a lateral orientation. The adjustment means may be in the form of set screws passing horizontally through the sides of the housing and acting against the sides of the guide plate.

While reference has been made throughout the present specification to the invention being intended for use with a vehicle, its use with racing simulators is also envisaged.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is an isometric view of an exemplary embodiment of the assembled invention;

FIG. 2 is a cross-sectional view of the user-operable means of the embodiment of FIG. 1 as fitted over a gear stick;

FIG. 3 is an illustration of a gear gate depicting the ideal path of travel for a gear stick through the gear gate;

FIG. 4a is a left isometric view of the guide plate of the embodiment of FIG. 1;

FIG. 4b is a right isometric view of the guide plate of the embodiment of FIG. 1;

FIG. 5a is a left isometric view of the guide plate of a further embodiment of the invention;

FIG. 5b is a right isometric view of the guide plate of a further embodiment of the invention;

FIG. 6a is a left isometric view of the guide plate of a further embodiment of the invention;

FIG. 6b is a right isometric view of the guide plate of a further embodiment of the invention;

FIG. 7a is a perspective view of the plunger head of the user-operable means of the embodiment of FIG. 1;

FIG. 7b is a perspective view of the plunger head of the user-operable means of a further embodiment of the invention;

FIG. 7c is a perspective view of the plunger head of the user-operable means of a further embodiment of the invention;

FIG. 8a is a left isometric view of another exemplary embodiment of the invention;

FIG. 8b is a cross-sectional view of the embodiment of FIG. 8a;

FIG. 9 is a perspective view of a further exemplary embodiment of the invention;

FIG. 10 is a top view of the housing of the embodiment of FIG. 9;

FIG. 11 is a top perspective view of the housing of a further embodiment of the invention;

FIG. 12 is a lower perspective view of the housing of a further embodiment of the invention;

FIG. 13 is a detail perspective view of the plunger of the embodiment of FIG. 9;

FIG. 14a is a plan view of one embodiment of the engagement portion;

FIG. 14b is a plan view of an alternative embodiment of the engagement portion;

FIG. 14c is a plan view of the embodiment of the engagement portion of the embodiment of FIG. 9;

FIG. 14d is a plan view of an alternative embodiment of the engagement portion;

FIG. 15 is an bottom view of the plunger of the embodiment of FIGS. 9 and 13;

FIG. 16a is a side view of the plunger of the embodiment of FIGS. 9 and 13 in a first position;

FIG. 16b is a further side view of the plunger of FIG. 16a in a second position;

FIG. 16c is a further side view of the plunger of FIGS. 16a and 16b in a third position;

FIG. 17a is a side view of the user-operable means of the embodiment of FIG. 9;

FIG. 17b is a further side view of the user operable means of FIG. 17a;

FIG. 18 is a side perspective view of an alternative embodiment of the user operable means;

FIG. 19 is a perspective view of an alternative embodiment of the invention; and

FIG. 20 is a perspective view of another alternative embodiment of the invention.

### DETAILED DESCRIPTION OF PREFERRED EMBODIMENTS OF THE INVENTION

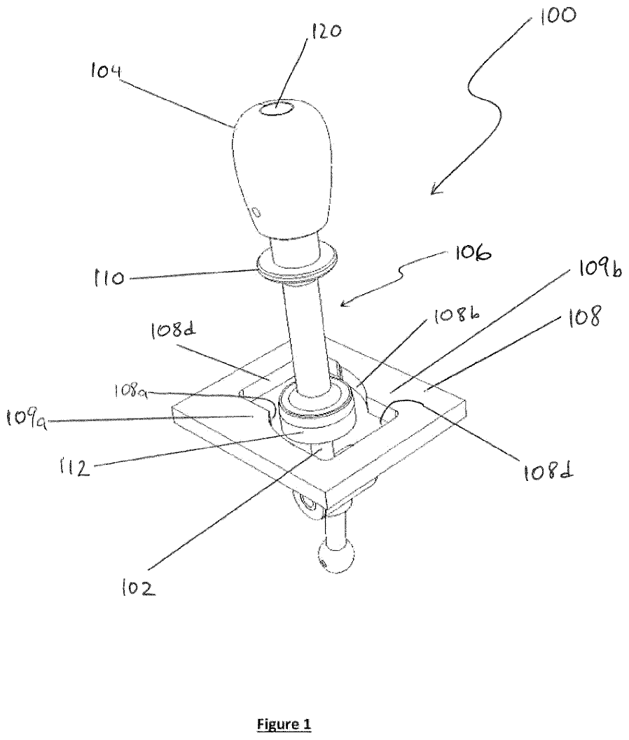

FIGS. 1 and 2 show, respectively, isometric and cross-sectional views of one embodiment of the invention, in a somewhat simplified configuration, in the form of a shift lockout guide (generally indicated by arrow 100) fitted over the top of a gear stick (102) that replaces the standard gear stick of the vehicle. However, it should be appreciated that the invention may, with minor modifications, also be used with a standard gear stick.

The gear stick includes a gear stick knob (104) beneath which is a user-operable means in the form of a plunger (106). The plunger (106) is configured with a lift collar (110) to assist the driver to raise the plunger (106) up along the gear stick shaft (102).

Also visible in FIG. 1 is the guide plate (108) which engages with the engagement portion (112) of the plunger (106). This has an interior defined by left (108a) and right (108b) contoured inner walls or edges and top (108c) and bottom (108d) walls or edges. When the engagement portion is within this interior, only certain gears may be available for selection depending on the configuration of the guide plate as will be apparent from the ensuing discussion.

The gear stick (102) is able to move within this interior, while the contoured walls (108a, 108b) define, as near as is possible, the ideal path of travel through which the gear stick (102) must move to select the next gear. The left wall (108a) defines the ideal path of travel for selection of third gear from second gear, while the right wall (108b) defines the ideal path of travel for selection of fifth gear from fourth gear. First gear and reverse gear are unavailable for selection since a portion (109a, 109b) of the guide plate (108) prevent the gear stick from being able to move into the appropriate position to select those gears.

The guide plate (108) is fitted externally to the top of the gear gate (not shown in this view) inside the vehicle. Fitted could mean via the use of attachment means such as screws or rivets. The top portion of the plunger is referred to as the plunger head (116). This portion of the plunger able to slide inside the underside of the gear stick knob (104).

Although not visible in FIG. 1, a spring, positioned below the gear stick knob (104), biases against the plunger (106), urging it downwards. The user can inactivate the biasing force of the spring by pulling upwards on the lift collar (110). It will be appreciated that this moves the engagement portion (112) into and out of the guide plate (108), depending on whether the spring is active or inactive. This action may be referred to as “stepping over”; the engagement portion is able to “step over” the guide plate and any gear may be selected. In particular, the portions (109a, 109b) of the guide plate (108) no longer form a barrier to the selection of first and reverse gears.

FIG. 2 is a cross-sectional view of the plunger (106) of the embodiment of FIG. 1 and it will be appreciated that this view shows the plunger (106) installed to the gear stick shaft (102) to which the gear stick knob (104) is fixed with a fastener in the form of a bolt (120). In this view, a cavity (118) is provided to the underside of the gear stick knob. This provides clearance for the upwards movement of the plunger, which occurs when the driver deactivates the biasing means.

Contained within the cavity (118) is the biasing means in the form of a return or expansion spring (not shown). Alternatively the spring (not shown) could be positioned between the lift collar (110) and underside (104a) of the gear stick knob (104). This urges the plunger (106) downwards into its default, active, position once the lift collar (110) is released by the driver. The bottom of the plunger (106) is configured to include a curved protrusion referred to as the engagement portion (112).

In use, the lift collar (110) is gripped, typically with two fingers, by the driver, raised and held upwards. This action lifts the plunger (106) and in turn, the engagement portion (112) clear of the top surface of the guide plate (108). With the engagement portion lifted clear of the guide plate (108) as depicted in FIG. 1, the gear stick (102) is able to be shifted into any gear available through the gear gate (not shown).

When the driver releases the lift collar (110) the biasing means (not shown) contained within the cavity (118) forces the plunger (106) into the active position. When the plunger (106) is in the default position and moved in the appropriate direction, the engagement portion (112) no longer engages with the top surface of the guide plate (108). Instead, it drops down into the open space defined by the interior of the guide plate. The contoured sides (108a, 108b) of the guide plate prevents the gear stick from being shifted into particular gears and is guided on an ideal path to select the correct gear, predetermined by the contours, while preventing other gears, such as first gear or reverse gear from being selected. To allow those gears to be selected, the driver grips and raises the lift collar (110), causing the engagement portion (112) to step over and contact the top surface of the guide plate (108).

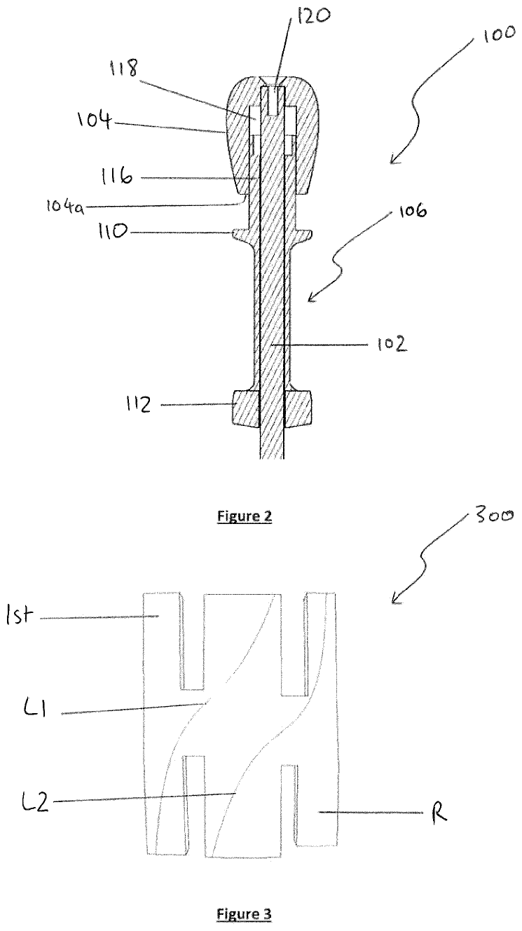

To further assist with understanding the functionality of the invention, FIG. 3 depicts a gear gate (300) of a standard H pattern 5 speed manual transmission gearbox and displays the ideal shift path for a gear stick to travel through the gear gate in order to engage the appropriate gear within the gearbox of the vehicle. L1 represents the ideal shift path from second gear to third and L2 represents the ideal shift path from fourth gear to fifth. The bottom right of the H-pattern is reverse gear (R). The top right of the H-pattern is first gear (1st).

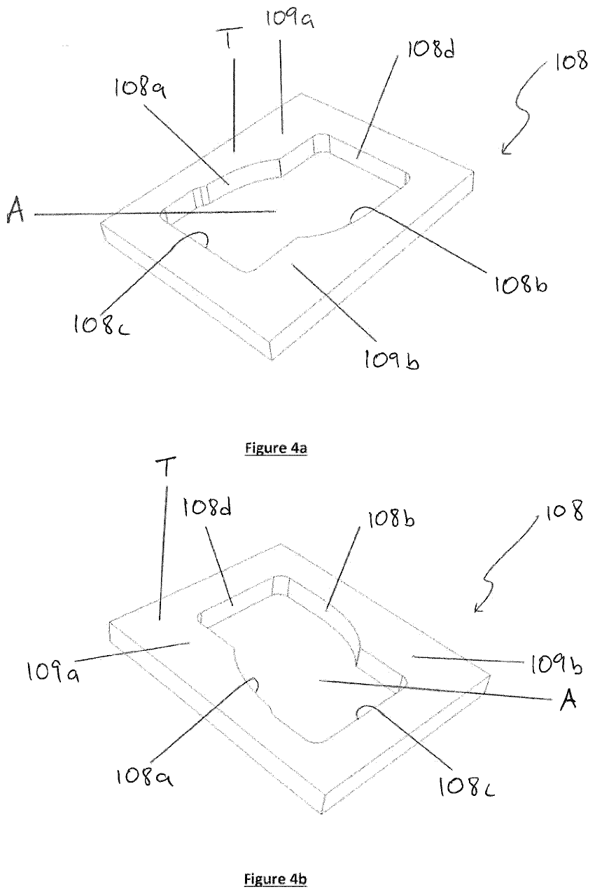

FIGS. 4a and 4b are views of the guide plate (108) of the of the embodiment of FIG. 1. It will be seen that the contoured left inner wall (108a) and right inner wall (108b) of the guide plate, together with the top and bottom inner walls (108c, 108d) define an area (A) within which the engagement portion (not shown) is able to be moved as the driver articulates the gearstick. These contoured walls (108a, 108b,108c,108d) serve as guide paths for the selection of certain gears. However, the presence of certain portions (109a, 109b) serve as a barrier to selection of other gears so these remain locked out.

Referring to the operation of the invention shown in FIGS. 1 to 4b, it should be appreciated that the contours of the left (108a) and right (108b) inner walls of the guide plate (108) are specifically contoured to engage with the engagement portion (112) in a complementary manner. This means that when the guide plate is in position above the gear gate (300) of FIG. 3, the engagement portion (112), when biased downwards by the spring (not visible) travels along these contoured walls in an ideal predetermined path. This places the user-operable means in the second position, in which a portion (109a) of the guide plate (108) prevents the driver from selecting certain gears. In the illustrated case, the unavailable gear is first gear, as the shape of the left contoured wall at this portion occludes the entry point in the gear gate that would otherwise allow for selection of first gear. Likewise, a portion (109b) of the right contoured wall occludes the entry point in the gear gate that would let the driver select reverse gear (R). However, the driver is freely able to move and select from second gear to fifth gear as required.

To select first gear (or reverse) the driver has to pull upwards on the lift collar (110) of the user operable means to deactivate or otherwise overcome the biasing force that has been applied by the spring to urge the engagement portion downwards into contact with the contoured walls. The engagement portion (112) then clears and steps over the guide plate (108). This places the user-operable means in the first position, which allows the selection of first gear (or reverse gear as the case may be). The engagement portion is now in contact with the top surface (T) of the guide plate (108).

It should be appreciated by a person skilled in the art that the configuration of the guide plate (108) will vary depending upon the gear gate and shift path of the gearbox of the vehicle with which the invention is to be used. This is determined by the vehicle manufacturer and will change depending upon the particular make and/or model of vehicle. In additional certain forms of motorsport may have specific requirements.

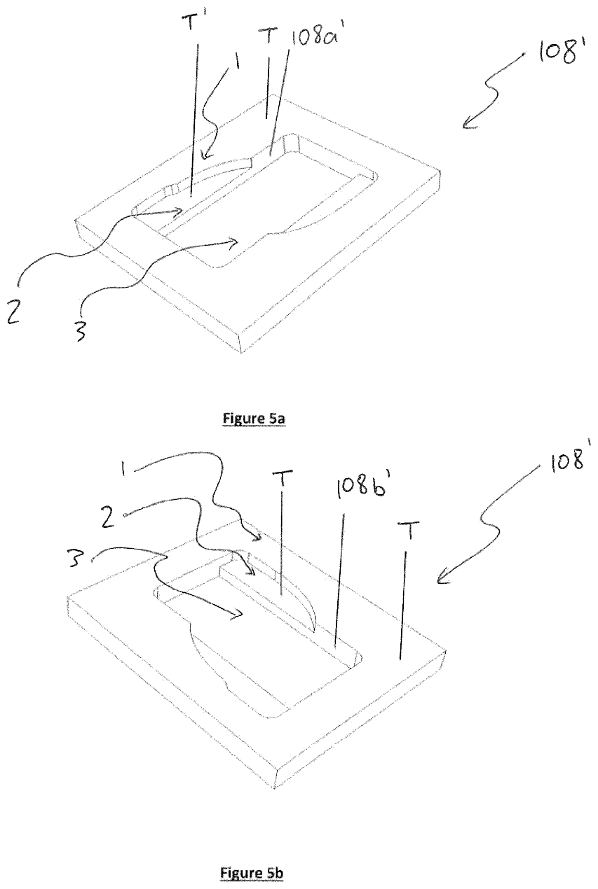

For example, drag racing gearboxes may only utilize forward gears first to fourth, without reverse. During a drag race, the gears only need to be shifted up once and never shifted down. An embodiment of the guide plate suitable for use in drag racing is shown in FIGS. 5a and 5b.

In these views, the guide plate (108′) is layered such that the inner left wall (108a′), seen in FIG. 5a, and the inner right wall (108b′), seen in FIG. 5b, respectively have two guide paths (1, 2). This embodiment of the invention has two step lock out functionality.

In use, the engagement portion (not shown in FIGS. 5a and 5b) bears against the top surface (T) of the guide plate; in this first guide path (1), the driver is able to select first gear. The gear stick is then moved towards the rear of the gear gate (not shown) in order to select second gear. In doing so, the engagement portion drops down and bears against the surface identified as T′. This is the second guide path (2). From here, it is not possible to select first gear again unless the driver operates the user-operable means to raise the plunger (not shown), and therefore the engagement portion (not shown) into the first guide path (1). The driver continues to move the gear stick towards the to the point where the engagement portion disengages from the second guide path (2) entirely. The engagement portion (not shown) is now in the third guide path (3) in which the third gear has been selected. However, the gear stick (not shown) cannot be returned to second gear; it has been locked out by the presence of the inner left wall (108a′) at the point corresponding to the entry point in the gear box gate (not shown) to second gear. The driver has to operate the user-operable means (not shown), deactivating the biasing means, in order to bring the engagement portion (not shown) up sufficiently enough to allow it to step over the inner wall (108a′) and return to the second guide path (2) so that second gear may be selected.

In the illustrated example, the guide plate (108′) is a unitary one-piece component. However, it should be appreciated that the guide plate may be formed from two separate plates, each having a different profile, laid on top of each other and secured through an interlocking arrangement or with fasteners.

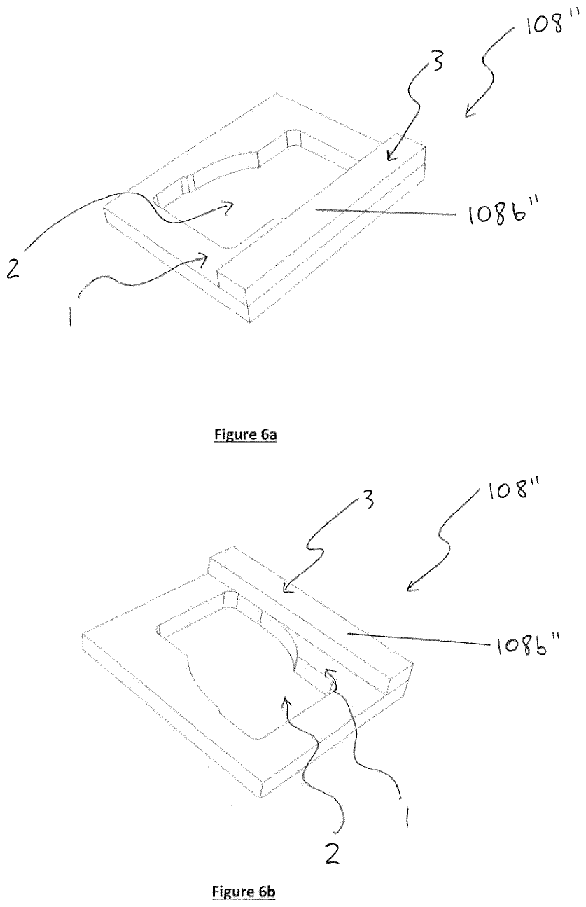

A similar principle to that of FIGS. 5a and 5b is applied to the embodiment of the guide plate (108″) of FIGS. 6a and 6b respectively, intended for use with a Japanese 6-speed manual gearbox where the reverse gear is positioned beside the sixth gear in the shift pattern; i.e. on the right side of the gear gate. In this embodiment, the right wall (108b″) of the guide plate is configured as a two-layer (1, 2) arrangement. When the engagement portion is on top of the first layer (1), reverse gear is locked out. When at the second layer (2), first gear is locked out. European 6-speed gearboxes are the opposite; reverse is located adjacent first gear. When using the invention in a European vehicle, the left side of the guide plate may be configured as two layers. The upper layer or step, defined by the upper surface of the guide plate locks out reverse gear; the second layer, defined by the lower surface of the guide plate locks out first gear.

In both cases, Japanese or European, the driver is able to select first gear by raising the plunger a first level or step. Reverse gear is then able to be selected by raising the plunger through to a second step, such that the engagement portion is on top of and bears down on the highest level (3).

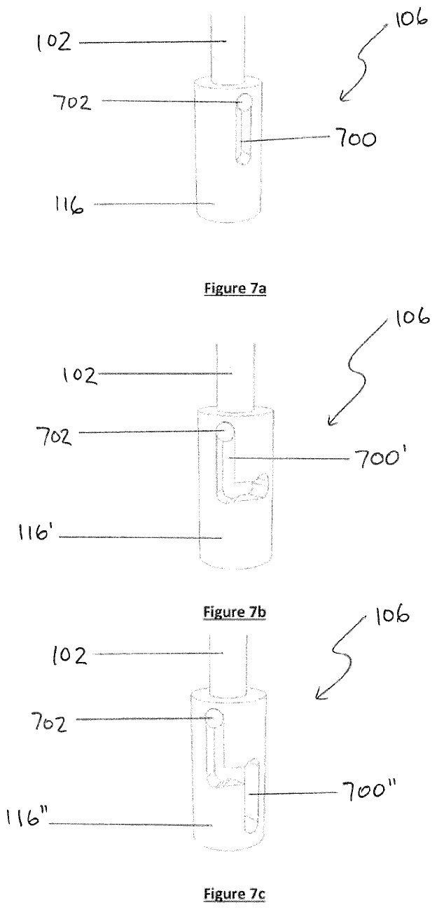

The plunger (106) may be configured in a variety of forms such as shown in FIGS. 7a, 7b and 7c, adapted for particular situations. In these views the upper end of the user-operable means/plunger (106) is referred to as the plunger head (116).

FIG. 7a is a perspective view of the plunger head (116) of the shift lockout guide (100) of the embodiment of FIG. 1. In this embodiment, the plunger simply moves vertically along a slot (700) with a pin (702), arising for the gear stick (102), constraining and preventing any rotation of the plunger through its travel. This embodiment is primarily intended for use with a standard 5 speed manual gearbox.

FIG. 7b is a perspective view of an alternative embodiment of the plunger head (116′). In this embodiment, the slot (700′) is substantially L-shaped and is able to move about the pin (702) in both a vertical and horizontal direction. This is useful, since it allows the driver to hold the plunger (106) in a raised position by rotating the plunger head horizontally such that the pin prevents vertical travel. Disengagement of the plunger could be desirable for instance when the vehicle is used alternatively between road and track.

FIG. 7c is a perspective view of yet another embodiment of the plunger head (116″) intended for use with Japanese or European six-speed gearboxes. As discussed above in respect of FIGS. 6a and 6b, the guide plate for these gearboxes may be configured as a two layer arrangement. This in turns requires the plunger head (116″) to have a two range movement about the gear stick shaft (102). As can be seen, the slot (700″) is configured as a substantially flattened S-shape, with two vertical slots linked by a horizontal slot. The two vertical elements define the extent of the two ranges of movement. When the plunger head has been articulated such that the pin (702) has moved into the lower vertical slot, the plunger (116″) is held locked in a raised position. In this position, reverse gear, and indeed any other gear, is able to be selected. When the plunger head has been articulated such that the pin is in the horizontal slot, reverse gear is locked out and unable to be selected. However, first gear can be selected. When the plunger head has been articulated such that the pin is at the upper end of the upper slot, both first and reverse gears are locked out and unable to be selected.

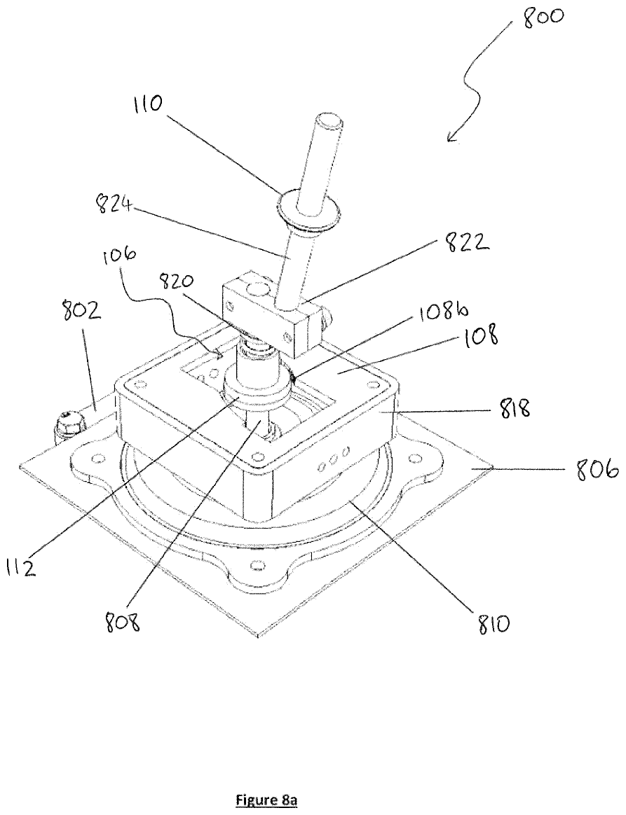

Another exemplary embodiment (800) of the invention is shown in FIGS. 8a and 8b. This embodiment allows for retrofitting onto an existing gear shift. Parts in common with the embodiment of FIG. 1 share like numbers.

In FIGS. 8a and 8b, parts of the vehicle to which the invention (800) is fitted are shown; these include the top plate (802) of the gearbox (804) and the sheet metal (806) of the chassis surrounding the sides of the gearbox. A gear shifter (808) passes through a rubber boot (810) to engage with the internals of the gearbox. As seen in FIG. 8b, the end of the gear shifter is formed as a ball (812) that is able to move about in a pivot housing (814) to select the appropriate gears. A separate boot, in this case the original boot (816), may be provided to further separate the external environment from the internals of the gearbox. This boot may be instead of the rubber boot (808) or in addition.

The guide plate (108) is disposed within a housing (818), which in turn is secured to the top plate (802) of the gear box (804) (alternatively, it could be secured to the sheet metal (806) of the chassis). This holds the guide plate parallel to the top of the gearbox. This simplifies the manufacturing process as the interior walls (only 108b shown for sake of clarity) of the guide plate may need less contouring from top to bottom. A further advantage of this arrangement is that the guide plate is easily removed from the housing. A new guide plate may then be inserted, which allows for the invention to be easily adapted in response to modifications to the gearbox.

The housing (818) may be arranged such that the guide plate (108) may be located at a range of heights or positions. This may be useful in compensating for the range of travel of the gear shifter (808).

A further difference to the previous embodiment described is the plunger (106) is formed as two distinct parts, which is contrast to that illustrated in FIG. 2. In FIG. 8b, it can be seen that the engagement portion (112) is proximate the guide plate (108) and is biased, through the use of a spring (820) acting against a bracket (822) mounted above the guide plate.

The bracket (822) is clamped or otherwise secured to the gear shifter (808). A gear knob shaft (824) is mounted at an angle to the bracket and this includes the lift collar (110). This gear knob shaft may be part of the original gear shifter (808), having been cut through partway along its length or may be a separate gear knob shaft, specifically configured for use with the present invention.

The bracket (822) includes a suitable aperture (826) to receive the gear knob shaft (824). This aperture may be provided at an angle such that the gear knob shaft (824) is also angled when it has been inserted. Alternatively, the bracket (822) may be provided with a mechanism that allows a range of angles to be selected or alternative, a number of brackets may be provided with apertures at varying angles, the driver selecting the bracket best matching their personal preference.

The manner of operation is essentially as previously described; the driver grips the lift collar (110) and pulls it upwards to deactivate or overcome the biasing force of the spring (820). In this embodiment, the entire gear knob shaft (824) and lift collar (110) is moved upwards (alternatively, in a pull-push cable arrangement, only the lift collar may move). This allows selection of any gear desired by the driver. Conversely, when the lift collar (110) is not in use, the spring (820) urges the engagement portion (112) downwards. Should the gear knob shaft (824) be sufficiently moved, the engagement portion moves off the top surface of the guide plate (108) and drops down into the interior defined by the contoured walls (108a, 108b). This locks out a pre-determined gear from selection by the driver unless the lift collar (110) is engaged.

If necessary, the lift collar (110) may include the pin and slot arrangement previous described in respect of FIGS. 7a and 7b. This allows for a two or more layered arrangement to lock out more than one gear in use.

An advantage of the invention is that in some embodiments, it can be assembled from modular components. As will be apparent from the discussion of the following embodiments, this makes it easy to mass produce for the manufacturer of the invention as fewer bespoke parts may be required to adapt it to a specific model or make of vehicle. For the consumer, such modularity may also make the invention easier to install and adjust depending on the vehicle to which it is to be fitted and the preference of the user of the vehicle.

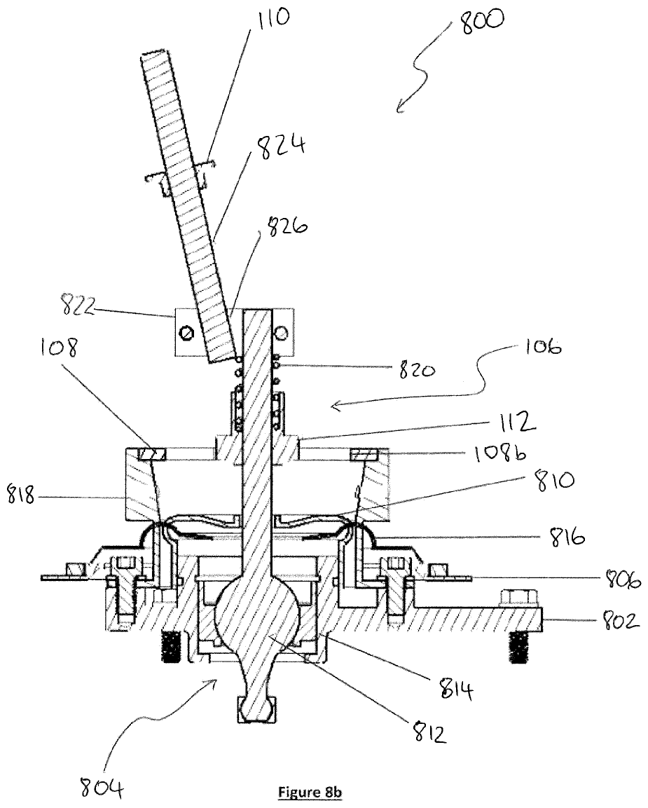

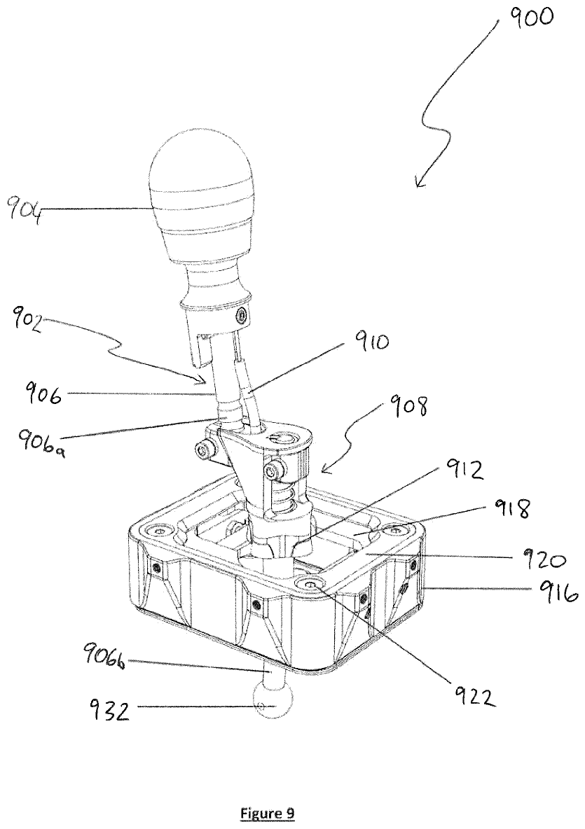

By way of illustration, FIG. 9 shows an exemplary embodiment of the invention (900), comprising of a gearstick (902) which includes a user operable means in the form of a gear knob (904) mounted to the shaft (906). The gear knob is linked to a plunger (908) via a cable (910). At the base of the plunger is provided an engagement means (912) which interacts with the guide plate (914) in order to lock out specific gears from selection by the user. The entire gear shifter (902) is surrounded by a housing (916) which in use is mounted to the gearbox (not shown) of the vehicle to which it is to be used, either directly or indirectly through the use of adapter components. The housing is configured to receive the guide plate (918) that interact with the engagement means (912) of the plunger (908) in order to lock out certain gears. The edges of the guide plate may rest on a lip or shelf (not visible) within the interior of the housing and then held in place through the use of an overlying clamping plate (920) secured with locking bolts (922).

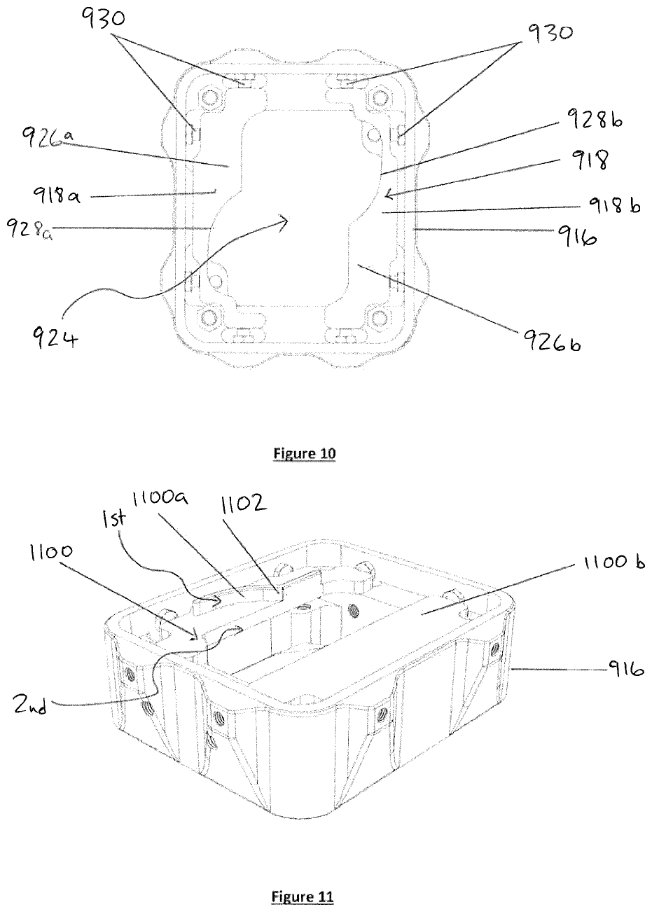

In FIG. 10, the housing (916) is shown in a top view without the clamping plate in place and in this view, it will be apparent that, in contrast to the embodiment of FIG. 4a for example, the guide plate (918) is formed from two separate components (918a, 918b) which between them define the space (924) in which the engagement means (not shown in this view) moves when certain gears are locked from selection. Access to those gears can only be achieved by the driver lifting the user-operable means (not shown), thus elevating the plunger and engagement portion clear of the guide plate (918).

The two components (918a, 918b) are arranged with a lockout portion (926a, 926b) and a contoured guiding surface (928a, 928b) that urges the gear stick along a predetermined path. In this view, first gear (top left) and reverse gear (bottom right) are prevented from being selected unless the plunger is pulled upwards by the driver. This leaves second gear through to fifth gear free for selection by the driver. Only when the engagement portion has been stepped clear of the guide plate, can either first or reverse gear be selected.

When installing the invention, there may be an element fine tuning required to optimise the guide path defined by guiding surface (928a, 928b) and/or lockout portion (926a, 926b) defined by the guide plate (918) with the action of the gear stick (not shown).

To facilitate easy adjustment of the guide path, set screws (930) are provided. These bear against the sides of the two components (918a, 918b) of the guide plate (918), allowing incremental adjustment as required, both laterally and longitudinally. Once the optimal position has been attained for operation of the gearstick (not shown) with the gearbox (not shown), the clamping plate (920 in FIG. 9) can be put in place and secured with locking bolts (922 in FIG. 9). This locks the guide plate (918) in place. However, it will still be possible to swap out the guide plates (for example, to lock out fifth gear and reverse gear as per the example of FIG. 11 as discussed below or to remove the lockout functionality altogether) simply be removing the clamping plate and replacing and or removing the relevant component or components. The set screws remain in place so that the optimal position previously achieved is not lost.

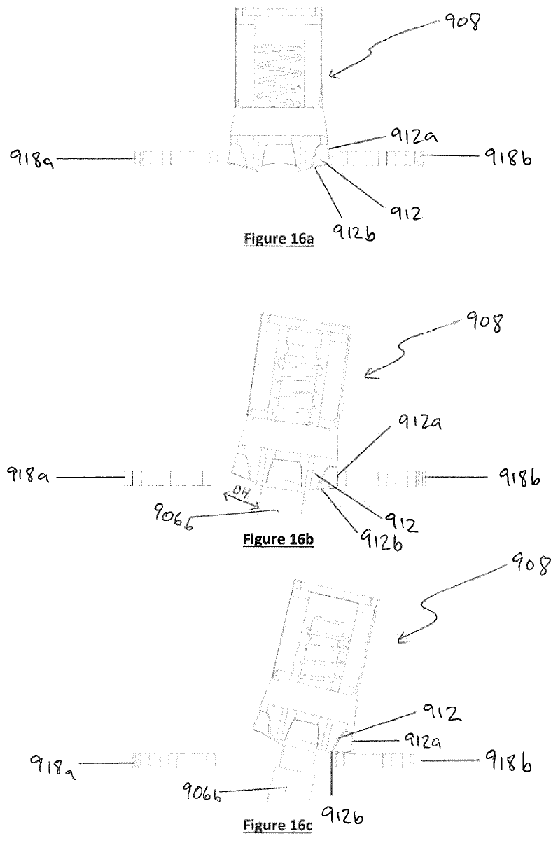

A more complex arrangement is shown in FIG. 11 in a perspective view. Although using the same housing (916), the components (1100a, 1100b) of the guide plate (1100) differ. On initial use, the engagement portion of the plunger (not shown) would be resting on top of the first component (1100a—in a manner similar to that shown later in FIG. 16c). In this position, first gear is selected. As the gear stick (not shown) is moved to the bottom left in order to select second gear, the engagement portion (not shown), being biased, then drops into the first guide path (1st). If the movement of the gear stick were reversed, i.e. moved to the top left, the engagement portion can only be directed into third gear The first guide path allows the gear stick to move from second gear to third gear but a portion (1102) prevents selection of first gear once second gear has been engaged.

The embodiment of FIG. 11 also includes a second guide path (2nd) which allows the gear stick (not shown) to move from third gear to fourth gear while preventing the selection of first and second gears entirely, unless the driver were to override the bias of the plunger (not shown) and elevate the engagement portion (not shown) and stepping it clear of the components (1100a, 1100b). The second component (1100b) lacks a guide path entirely; it serves as a barrier to prevent the selection of fifth and reverse gears.

The arrangement of FIG. 11 may be particularly preferred for use in drag racing, since the objective is to gain speed as quickly as possible but when inadvertent selection of a lower gear than desired could cause considerable overrevving of the engine. The arrangement of FIG. 10 may be preferred in circuit racing, where first gear is unlikely to be required after the race has been started but the driver still wants to have the flexibility to choose as desired from the remaining gears, except for reverse gear.

In FIG. 11, the first component (1100a) is unitary but as previously mentioned above provides two guide paths. A similar effect may be achieved by stacking two differently profiled guide plates on top of each other. This may simplify manufacture of the guide plate (1100).

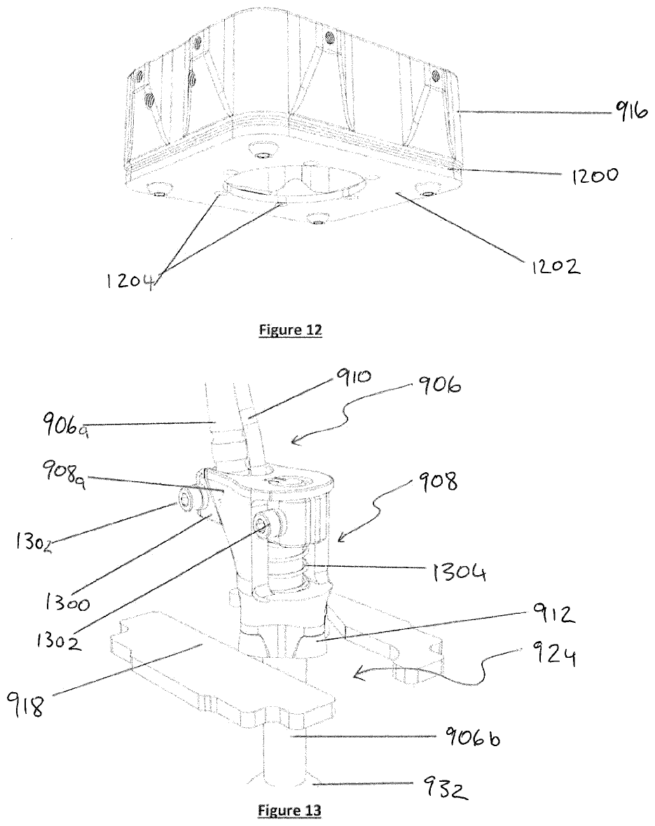

There are ways in which the housing (916) may be adapted for either optimising its placement in the vehicle or for the personal preference of the driver. For example, as shown in FIG. 12, the vertical height of the housing (916) relative to the gearbox may be adjusted through the use of one or more spacer plates (1200) mounted to the housing (916) and the mounting plate (1202) of same.

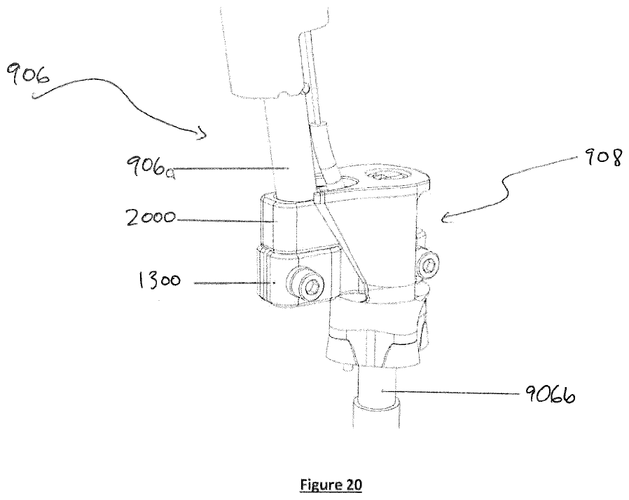

Holes (1204) provided to the mounting plate (1202), which may be specific to the make and model of the vehicle with which the invention is to be used, allow the use of bolts (not shown) to secure the housing to the gear box of the vehicle. In some examples, for example, that of FIG. 19, the mounting plate (1202) may be provided with a pivot housing (1900) within which the lower part (not visible) of the gear stick moves when engaging the desired gear.

Returning to FIG. 9, as with the embodiment of FIGS. 8a and 8b, the shaft (906) of the gearstick is formed as two parts; an upper part (906a) and a lower part (906b). The upper part may be standardised irrespective of the make and model of vehicle, but the lower part may be dependent on the vehicle with which the invention is to be used. The lower part ends in a pivot point (932) that engages with the gearbox (not shown) of the vehicle.

As more clearly appreciated from FIG. 13, the respective upper (906a) and lower parts (906b) of the shaft of the gearstick are connected to each other via a bracket (1300). The bracket may be loosened and removed by undoing hex-bolts (1302). This two-part arrangement for the shaft (906) of the gearstick (902) allows the possibility of an off-set and/or angled gearstick. The user can orientate the upper part (906a) at a slight incline towards the driver in use.

The bracket (1300) also serves as a means of providing control to the movement of the plunger (908), ensuring that the direction of travel is substantially vertical, along the lower part (906b) of the shaft (906) and that there is no inadvertent rotation when the driver operates the plunger and engagement portion. As can be seen, the plunger (908) is provided with a wing (908a) that extends laterally past the shaft (906) and overlays the bracket (1300). The mating surfaces are flat and thus limit any rotational movement, allowing only vertical movement.

Also seen in FIG. 13 is the biasing means in the form of a spring (1304); this constantly urges the plunger (908) and its engagement portion (912) downwards. Once the engagement portion (912) is located within the space (924) defined by the guide plate (918), certain gears are locked out from selection. However, as the plunger (908) is linked to the cable (910) which in turn is linked to the gear knob (not shown), when the driver raises the plunger (908), this in turn elevates the engagement portion (912) such that it is above the guide plate (918) and allows selection of previously unavailable gears.

Although FIG. 13 shows the plunger (908) as being located between the pivot point (932) and the gear knob (not shown) it should be appreciated that it could alternatively be located beneath the pivot point (932). This may be useful when a significant amount of clearance between the engagement portion (912) and the guide plate (918) is required. Greater reach will be required in such a configuration so the plunger (908) may require a greater amount of travel than the example of FIG. 13.

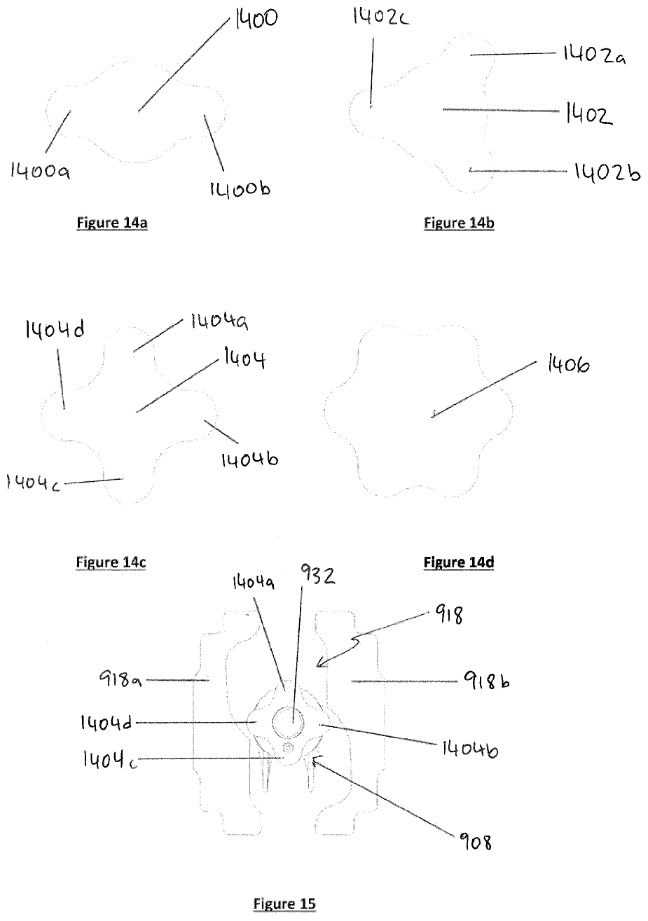

The engagement (portion may take a number of profiles as shown in a plan view in FIGS. 14a to 14d. For example, the engagement portion (1400) of FIG. 14a only has two lobes (1400a, 1400b); this provides for 180 degrees of rotation whereas the engagement portion (1402) of FIG. 14b, having three lobes (1402a, 1402b, 1402c) equidistance apart provides for 120 degrees of rotation. With further lobes provided to the engagement portion (1404, 1406), as shown in FIGS. 14c and 14d, further options are provided as to the alignment of the gear stick (not shown). This allows for differing amounts of rotation for the bracket and upper shaft of the gear stick during the installation of the invention to the vehicle. This helps optimise the placement of the gear stick according to the preferences of the driver.

The lobes interact with the guide paths defined by the guide plate (918), as will be apparent from FIG. 15. In this view, from the underside of the gear stick (only the pivot point 932 being visible), the engagement portion (1404) has four lobes (1404a, 1404b,1404c,1404d) as per the example of FIG. 14c. However, only the left and right lobes (1404b, 1404d) actively interact with the guide plate components (918a, 918b). The top and bottom lobes (1404a, 1404c) are unused, unless the plunger (908) were to be rotated by 90 degrees. When using a two-part gear stick, such as that of FIG. 13, such a rotation may place the gear stick at an angle to the driver. If this rotation occurs, it is the top and bottom lobes (1404a, 1404c) that now interact with the guide plate components (918a, 918b), and the left and right lobes (1404b, 1404d) are now inactive.

The profile of the engagement portion (1404) of FIGS. 14c and 15 is that of a quatrefoil and is particularly useful since it helps optimise the interaction with the guide path defined by the guide plate components (918a, 918b) while still retaining sufficient functionality to select gears with the greatest range of movement between them; for example, second and fifth gears.

It will be appreciated that in most gearboxes, the gearstick will be at a slight angle when engaged in a specific gear. This may affect the extent to which the plunger must be raised in order to select a previously locked out gear. The respective contact surfaces between the engagement portion and guide plate components are also important and can be configured for smooth and optimal functioning. This will be apparent from FIGS. 16a to 16c, which show the plunger (908) and engagement portion (912) in respect of the guide plate components (918a, 198b).

In FIG. 16a, the plunger (908) is in a vertical position, as it may be if the gear stick (not shown) to which it is mounted was in the neutral of the gear box gate (not shown). From this it will be seen that the sides (912a) of the engagement portion (912) are at an angle. Similarly, the underside (912b) of the engagement portion is also angled.

In use, this maximises the contact between the sides (912a) and underside (912b) of the engagement portion (912) and guide plate components (918a, 918b) when the invention is in use. The contact surfaces are substantially parallel, regardless of whether certain gears are locked out, as in FIG. 16b or if all gears are available, as shown in FIG. 16c, where the underside (912b) of the engagement portion (912) is contacting the upper surface of the guide plate component (918b). This optimises the contact surfaces and has implications for wear and tear of the respective parts. It also helps ensure positive engagement or disengagement when operating the invention.

In FIGS. 16a to 16c it will be noted that there is an overhang (OH in FIG. 16b), determined by the lateral projection of the engagement portion (912) from the lower portion (906b) of the shaft of the gearstick. This overhang should slightly exceed the range of lateral movement able to be performed by the gear stick as it moves across the gearbox (not shown). It will be appreciated that if the overhang is less than this it may not be possible to achieve sufficient lateral movement to have the underside of the engagement portion contacting the upper surface of the guide plate components, as in FIG. 16c.

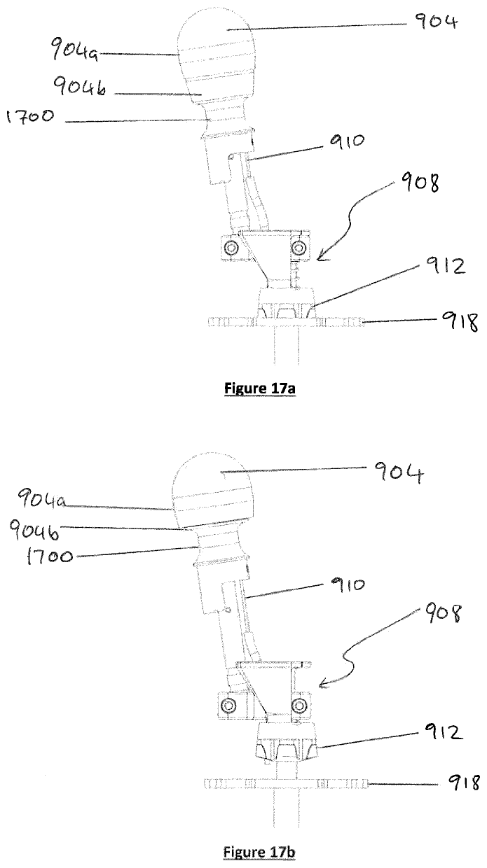

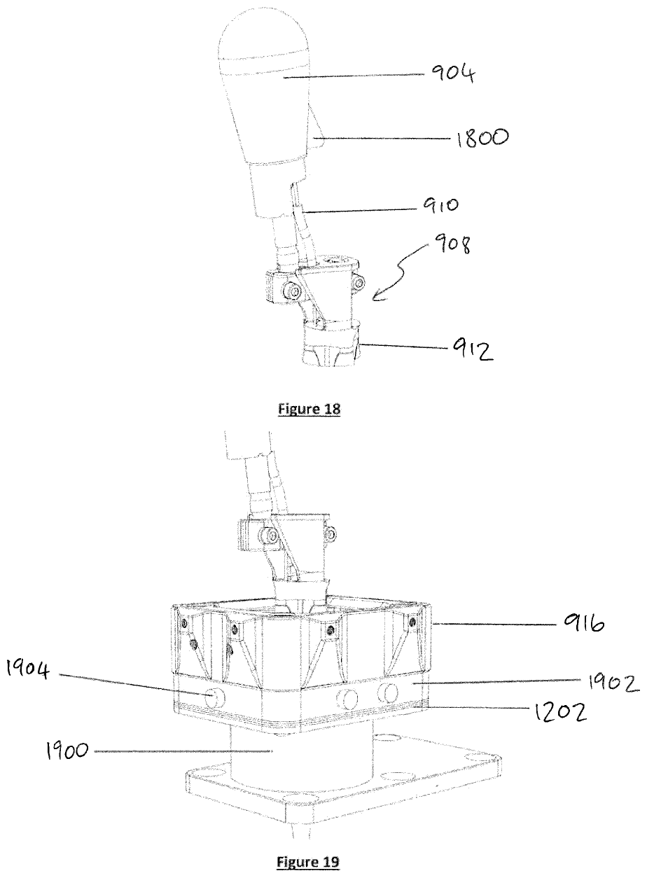

FIGS. 17a and 17b show the gear knob (904) of FIG. 9 in a side view and illustrates its two-part assembly of an upper half (904a) and a lower half (904b). The upper half (904a) is substantially dome shaped, while the lower half (904b), which is functionally similar to the lift collar of the embodiment of FIGS. 1 and 2, is contoured to be substantially complementary but with a gripping surface (1700) for the fingers of the driver.

In FIG. 17a, the lower half (904b) is distended such that the engagement portion (912) is either resting on the guide plate (918) or is within the guide paths (not visible) defined by the guide plate (918). FIG. 17b shows the lower half (904b) retracted partially into the upper half of the gear knob. This has resulted in the withdrawal or shortening of the cable (910) and compression of the biasing spring (not visible), thus raising the plunger (908) and the engagement portion (912) of the plunger (908) clear of the guide plate (918). This allows the driver to select any desired gear. Although not seen here, there may be a spring or bung in the interior space between the upper (904a) and lower (904b) halves of the gear knob (904) to provide some resistance. This provides the driver with direct tactile feedback as to the relative position of the plunger (908).

However, the user operable means may take other forms. For example, as shown in FIG. 18, it may be a trigger button (1800) provided to the gear knob (904). When the button is depressed in order to render all gears operative, this withdraws the cable (910) to the plunger (908), thus causing the engagement portion (912) to move clear of the guide plate (not shown in this view).

The invention may include additional components to enhance functionality. For example, as shown in FIG. 19, the housing (916) may co-operate with a sandwich plate (1902) positioned between it and the mounting plate. Mounted to the sandwich plate may be a series of electronic sensors (1904) which detect the position of the lower portion (not visible) of the shaft of the gear stick within the housing (916) and sends this remotely to a central processing station (not shown).

While the present invention lends itself to easy disassembly if the lock out functionality is no none desired, it can be rendered inoperative simply by locking the plunger (908) in its elevated or “stepped over” state so that it cannot return to a locked out position regardless of the movement of the gear stick. An example of how this may be achieved is illustrated in FIG. 20. In this instance, a clip (2000) has been added to the upper part (906a) of the shaft (906) of the gear stick, atop of the bracket (1300) that connects the upper part to the lower part of the shaft. The clip engages with the plunger (908), preventing its downward travel despite the inherent bias exerted by the spring (not visible in this view).

A similar effect may be achieved by configuring the plunger and the bracket with apertures which, when in alignment, allow for a sturdy pin to be inserted, thus locking the plunger to the bracket and preventing any downward travel.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. An attachment for a gear change assembly for a vehicle, wherein the gear change assembly includes a gear shifter for selection of a gear from a plurality of gears, wherein the attachment includes:
a user-operable means mounted to the gear shifter;
a biasing means, wherein the biasing means is configured to act against the user-operable means; and
a lockout means;
and wherein when the user-operable means is in a first position, the biasing means is deactivated enabling the gear shifter to select any gear from the plurality of gears, and wherein when the user-operable means is in a second position, the biasing means is activated, engaging the user-operable means with the lockout means to predetermine a specific gear from the plurality of gears for selection,
characterised in that
the lock out means includes an engagement portion and one or more guide plates, wherein the one or more guide plates are configured with a first surface defining a guide path for the engagement portion for selection of the specific gear from the plurality of gears for selection, and a second surface defining a guide path for selection of a further gear from the plurality of gears for selection.

2. The attachment as claimed in claim 1, wherein the attachment includes a housing configured to receive the one or more guide plates.

3. The attachment as claimed in claim 1, wherein the housing includes a mounting plate to connect the attachment to the vehicle.

4. The attachment as claimed in claim 1, wherein the first surface is a first edge of a first guide plate and the second surface is a second edge of the first guide plate.

5. The attachment as claimed in claim 1, wherein the first surface is a first edge of a first guide plate and the second surface is an upper side of the first guide plate.

6. The attachment as claimed in claim 1, wherein the first surface is a first edge of a first guide plate and the second surface is a first edge of a second guide plate.

7. The attachment as claimed in claim 1, wherein the first surface is a first edge of a first guide plate and the second surface is an upper side of a second guide plate.

8. The attachment as claimed in claim 1, wherein the gear shifter is a gear stick having a shaft and a gear knob.

9. The attachment as claimed in claim 8, wherein the shaft has a first portion and a second portion connected to each other with a bracket.

10. The attachment as claimed in claim 8, wherein the user-operable means is a plunger mounted to and configured to move along at least a portion of the shaft of the gear stick.

11. The attachment as claimed in claim 8, wherein the plunger is integrated with the gear knob.

12. The attachment as claimed in claim 8, wherein the plunger is linked to the gear knob via a cable or rod.

13. The attachment as claimed in claim 8, wherein the gear knob has a first portion configured to be movable relative to a second portion.

14. The attachment as claimed in claim 12, wherein the first portion of the gear knob is the user-operable means.

15. The attachment as claimed in claim 1, wherein the biasing means is a spring.

16. The attachment as claimed in claim 1, wherein the engagement portion has a quatrefoil profile in plan view.

17. The attachment as claimed in claim 1, wherein the attachment includes a clamping plate for the one or more guide plates.

18. The attachment as claimed in claim 1, wherein the attachment includes an adjusting means configured act against an edge of the one or more guide plates.

19. The attachment as claimed in claim 1, wherein the attachment includes a locking mechanism to lock the user-operable means relative to the gear shifter.

20. A kit set for an attachment for a gear change assembly for a vehicle, wherein the gear change assembly includes a gear shifter for selection of a gear from a plurality of gears, wherein the kit set includes:
a user-operable means for mounting to the gear shifter;
a biasing means, wherein the biasing means is configured to act against the user-operable means; and
a lockout means;
and wherein when the user-operable means is in a first position, the biasing means is deactivated enabling the gear shifter to select any gear from the plurality of gears, and wherein when the user-operable means is in a second position, the biasing means is activated, engaging the user-operable means with the lockout means to predetermine a specific gear from the plurality of gears for selection,
characterised in that
the lock out means includes an engagement portion and one or more guide plates, wherein the one or more guide plates are configured with a first surface defining a guide path for the engagement portion for selection of the specific gear from the plurality of gears for selection, and a second surface for selection of a further gear from the plurality of gears for selection.

21. The kit set as claimed in claim 20, wherein the kit set also includes a gear shifter for the vehicle.

22. The kit set as claimed in claim 20, wherein the kit set includes one or more of:
a) a housing for the attachment;
b) a mounting plate;
c) a locking mechanism for the user-operable means; and/or
d) gear position sensors.

23. A vehicle, wherein the vehicle includes a gear change assembly including a plurality of gears and a gear shifter for selection of a gear from the plurality of gears, and wherein the vehicle includes an attachment for the gear change assembly as claimed in claim 1.
